(19) United States
(12) Patent Application Publication
(10) Pub. No.: US 2008/0016325 A1
(43) Pub. Date: Jan. 17, 2008

(54) Using windowed register file to checkpoint register state

(76) Inventors: James P. Laudon, Madison, WI (US); Adam R. Talcott, Los Altos, CA (US); Sanjay Patel, Fremont, CA (US); Thirumalai S. Suresh, Santa Clara, CA (US)

Correspondence Address: MHKKG/SUN, P.O. BOX 398, AUSTIN, TX, 78767, US

(21) Appl. No.: 11/484,970

(22) Filed: Jul. 12, 2006

(51) Int. Cl. G06F 9/30

(52) U.S. Cl. 712/217

(57) ABSTRACT

In one embodiment, a processor comprises a core configured to execute instructions; a register file comprising a plurality of storage locations; and a window management unit. The window management unit is configured to operate the plurality of storage locations as a plurality of windows, wherein register addresses encoded into the instructions identify storage locations among a subset of the plurality of storage locations that are within a current window. Additionally, the window management unit is configured to allocate a second window in response to a predetermined event. One of the current window and the second window serves as a checkpoint of register state, and the other one of the current window and the second window is updated in response to instructions processed subsequent to the checkpoint. The checkpoint may be restored if the speculative execution results are discarded.

### BACKGROUND

1. Field of the Invention

This invention is related to the field of processors and, more particularly, to checkpointing registers for speculative execution in processors.

2. Description of the Related Art

Processors comprise circuitry that executes instructions defined in an instruction set architecture implemented by the processor. Essentially, the instruction set architecture is a definition, for software writers/compilers, of a set of instructions that can be supplied to the processor and the effect of executing these instructions in the processor. A processor can be a single integrated circuit having an interface by which the processor communicates with other integrated circuits (often referred to as a microprocessor). Additionally, multiple processors can be included on a single integrated circuit in a so-called multi-core configuration. The multi-core chip can be chip multithreaded (CMT), chip multiprocessor (CMP), or both. The single or multiple processor integrated circuit can also have other units integrated onto it (e.g. a memory controller, a bridge to a peripheral interface or device, etc.). Furthermore, processors can be implemented as multi-chip sets.

An instruction set architecture generally defines load operations (or more briefly “loads”) and store operations (or more briefly, “stores”). Load operations involve a transfer of data from main memory to the processor, while store operations involve a transfer of data from the processor to main memory. One or more operands of the load/store are used to generate the address of the main memory location for the transfer (and the address may be a virtual address that is translated to a physical address, if translation is enabled). The data transfers can be completed in cache if the load/store is cacheable. Load operations may be explicit load instructions and/or an implicit operation in another instruction (e.g. an arithmetic/logic instruction that can specify a memory operand), depending on the instruction set architecture. Similarly, store operations may be explicit store instructions and/or an implicit operation in another instruction.

Processors are designed to execute instructions as efficiently as possible. However, there are conditions that cause instruction execution to be delayed. For example, processors often implement caches to reduce the memory latency required to access memory data. Typically, cache hit data is provided within one to a few clock cycles after a request is presented to the cache. If a cache miss occurs (that is, the requested data is not stored in the cache), then a much longer memory latency occurs (e.g. 100 or more clock cycles, currently). For loads, the data being read may be required for execution of instructions dependent on the read data. Thus, instruction processing may stall fairly rapidly after a load miss in the cache, until the data is provided.

Some processors implement a “run-ahead” mode (also sometimes referred to as “scout mode”). In this mode, the processor continues to process instructions beyond the load miss in the code sequence, attempting to identify additional misses that can be serviced in parallel. By overlapping the memory latency of the additional misses with the original miss, performance can be increased. However, since this processing is speculative and may produce erroneous results, the state of the processor must be checkpointed at the load miss, so that real instruction execution can continue at the next instruction following the load miss, after the missing data is returned from main memory. There can be many other reasons for creating a checkpoint, including any type of speculative execution and even non-speculative execution, if restoring register state to a previous checkpoint may be required.

Checkpointing typically involves additional structures in the processor (e.g. an additional memory to store the checkpoint, used only for checkpointing). For example, processors that implement register renaming often implement a memory to store the map of logical registers to physical registers as a checkpoint. The additional structures are expensive in terms of chip area and complexity, complicating the design and verification of the processor.

### SUMMARY

In one embodiment, a processor comprises a core configured to execute instructions; a register file coupled to the core and comprising a plurality of storage locations; and a window management unit coupled to the register file and the core. The window management unit is configured to operate the plurality of storage locations as a plurality of windows, wherein register addresses encoded into the instructions identify storage locations among a subset of the plurality of storage locations that are within a current window of the plurality of windows. Additionally, the window management unit is configured to allocate a second window in response to a predetermined event. One of the current window and the second window serves as a checkpoint of register state, and the other one of the current window and the second window is updated in response to instructions processed subsequent to the checkpoint.

In one embodiment, the predetermined event may be entry into a run-ahead mode. The checkpoint may correspond to entry into the run-ahead mode (e.g. at a load cache miss), so results of instructions executed in the run-ahead mode can be discarded. In another embodiment, the predetermined event may be execution of an instruction that initiates a transactional memory operation. The checkpoint may be the register state prior to the beginning of the transaction, and thus may be used to restore the register state if the transaction fails. Still other embodiments may use other predetermined events.

### BRIEF DESCRIPTION OF THE DRAWINGS

The following detailed description makes reference to the accompanying drawings, which are now briefly described.

FIG. 1 is a block diagram of one embodiment of a processor.

FIG. 2 is a block diagram illustrating one embodiment of a windowed register set.

FIG. 3 is a flowchart illustrating one embodiment of entering run-ahead mode.

FIG. 4 is a flowchart illustrating one embodiment of execution in run-ahead mode and exiting run-ahead mode.

FIG. 5 is a flowchart illustrating one embodiment of execution of transactional memory using a windowed register file to checkpoint state.

FIG. 6 is a block diagram of a computer system.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF EMBODIMENTS

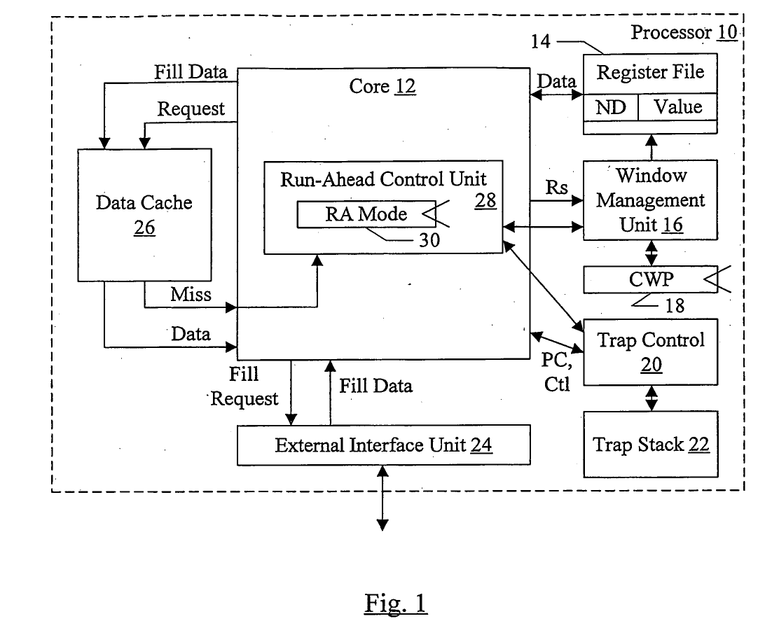

Turning now to FIG. 1, a block diagram of one embodiment of a processor 10 is shown. In the illustrated embodiment, the processor 10 comprises a core 12, a register file 14, a window management unit 16, a current window pointer (CWP) register 18, a trap control unit 20, a trap stack 22, an external interface unit 24, and a data cache 26. The core 12 comprises a run-ahead control unit 28, which includes a run-ahead (RA) mode register 30. The core 12 is coupled to provide a request (and fill data, for cache fills) to the data cache 26 and to receive a miss signal and data from the data cache 26. The miss signal is coupled to the run-ahead control unit 28. The core 12 is coupled to provide a fill request to the external interface unit 24, and is coupled to receive fill data from the external interface 24. The core 12 is coupled to receive/provide data from/to the register file 14. The core 12 is coupled to provide register addresses (Rs) to the window management unit 16 for register file read/writes, and the window management unit 16 is further coupled to the run-ahead control unit 28 and the CWP register 18. The trap control unit 20 is coupled to receive/provide program counter (PC) and control signals from/to the core 12, and is coupled to the run-ahead control unit 28. The external interface unit 24 is coupled to an external interface by which the processor communicates with other parts of a system that includes the processor.

The core 12 is configured to fetch and execute instructions defined in the instruction set architecture implemented by the processor 10. An instruction cache (not shown) may be provided to store instructions for fetching by the core 12. The core 12 may fetch register operands from the register file 14 and update destination registers in the register file 14. Similarly, the core 12 may read/write memory locations via the data cache 26 in response to loads and stores. More particularly, the core 12 may issue read/write requests to the data cache 26 (Request in FIG. 1) and may receive a miss signal indicating, when asserted, that the request misses in the data cache 26 (and thus a hit is indicated if the miss signal is deasserted). The core 12 may also receive data if the request is a hit. The core 12 may provide fill data when a cache fill occurs for a missing cache line (and the same path or a different path may be provided for write data).

The core 12 may employ any suitable construction. For example, the core 12 may be a superpipelined core, a superscalar core, or a combination thereof. The core 12 may employ out of order speculative execution or in order execution. The core 12 may include microcoding for one or more instructions or trap events, in combination with any of the above constructions. The core 12 may be a multithreaded or singlethreaded core, and may implement fine or coarse grain multithreading if multithreaded. The core 12 may be one of multiple cores within the processor 10, and may implement one or more strands (the hardware dedicated to a thread in a multithreaded implementation) in such a configuration. Alternatively or in addition, the processor 10 may be one core of a multicore integrated circuit in a CMT and/or CMP configuration.

The processor 10 may implement a run-ahead mode using the run-ahead control unit 28 in the core 12. The run-ahead control unit 28 may detect one or more long-latency events which cause instruction execution to stall, and may enter the run-ahead mode in response to the events. In the illustrated embodiment, the run-ahead control unit 28 may indicate whether or not the processor 10 is in run-ahead mode via the RA mode bit in the register 30 (or other storage device). The RA mode may be visible to the core 12 to control instruction processing in run-ahead mode or normal mode. Generally, run-ahead mode may be a speculative processing mode in which the instructions are executed without committing the results to architected state, in an attempt to uncover additional long-latency events that occur subsequent to the current long-latency event. If additional long-latency events are uncovered, the processor 10 may initiate processing of those events and thus may experience at least some of the latency of those additional events in parallel with the current event. Overall processor performance may be improved, in some embodiments, by detecting such events and overlapping the corresponding latencies.

For example, in one embodiment, a load cache miss is a long-latency event (to access a second level (L2) cache or main memory (not shown)). The run-ahead control unit 28 may detect the cache miss via the miss signal and may enter run-ahead mode. In run-ahead mode, the core 12 may execute instructions to detect additional cache misses, and may initiate cache fills for those additional cache misses in parallel with (or at least overlapping with) the cache fill for the originally-detected cache miss. Generally, a cache fill may be an operation that retrieves a cache block in response to a cache miss (either from another cache or main memory) and stores it into a cache block storage location in the cache. For the remainder of this description, the load miss event will be used as an example of a long-latency event that triggers entry into run-ahead mode. However, any long latency event may be used as a trigger (e.g. a load/store miss in a data translation lookaside buffer (DTLB), a load miss in another cache level (L2, L3, etc.), exception, or trap, etc.) and any set of long-latency events may be used.

In one embodiment, the instruction set architecture implemented by the processor 10 specifies register windows for the registers addressable by instructions. For example, one embodiment may implement the SPARC instruction set architecture. Other embodiments may implement other architectures that specify register windows (e.g. the AMD 29000 instruction set architecture, the Intel i960 instruction set architecture, the Intel Itanium (IA-64) instruction set architecture, etc.). Generally, the processor 10 may implement a group of registers in the register file 14 that are greater in number than the number of registers that are directly addressable using instruction encodings. A register window may be a subset of the implemented registers that are available for addressing by instructions at a given point in time. Registers in the currently-active register window (usually referred to as the “current register window” or simply the “current window”) are mapped to the register addresses that can be specified in the instructions. If the current register window is changed to another register window, the registers addressable by instructions are changed. In some embodiments, adjacent register windows may be defined to overlap in the implemented registers, such that some registers are included in both windows (e.g. the SPARC instruction set defines a register window for 24 of the 32 addressable registers, the remaining 8 registers are global registers which are not affected when the register window is changed, and 16 of the 24 register overlap with adjacent windows).

The processor 10 may allocate a currently-unused register window for run-ahead mode. That is, at any given point in time, some register windows may not be storing any valid data. For example, if a register window has not yet been allocated to a code sequence executing on the processor 10, it may be currently unused. If a register window was allocated to a code sequence but subsequently deallocated by spilling the registers to memory or terminating the code sequence, it may be currently unused. The processor 10 may make the newly allocated register window the current register window, and thus the previous register window may serve as a checkpoint at which run-ahead mode was entered, so that normal execution may be continued from the checkpoint. The contents of the checkpoint may also be copied to the newly allocated window, to be used as sources for instructions processed in run-ahead mode. Alternatively, the processor 10 may use the newly allocated register window as the checkpoint storage, copying the contents of the current register window to the newly allocated register window and restoring the data to the current register window when run-ahead mode is exited. Accordingly, in run-ahead mode, instruction execution may be similar to executing instructions in normal mode (non-run-ahead mode) and results may be written to the current register window. The checkpoint may be restored when run-ahead mode is exited and normal mode resumes.

In one embodiment, there is no overlapping register state between register windows. In such an embodiment, the window allocated upon entry into run-ahead mode may be adjacent to the current register window. In other embodiments, e.g. embodiments implement the SPARC instruction set architecture, some register state does overlap between adjacent windows. In such embodiments, the allocated window may be non-adjacent to the current window and may be allocated so as not to overlap with the current window.

Allocating a currently-unused window for run-ahead mode (and thus providing a checkpoint for normal mode in either the current register window, if the window is changed for run-ahead mode, or the newly allocated register window, if the window is not changed for run-ahead mode) may permit storage that is provided in the register file 14 for window support to also be used for checkpointing. In some embodiments, the cost of supporting run-ahead mode may be reduced because additional storage for checkpointing for run-ahead mode may not be required.

While register windows are used to checkpoint register state for run-ahead mode in the above discussion, register windows may be allocated for checkpointing register state for other purposes as well. For example, register windows may be used as checkpoints for transactional memory operations, as described in more detail below, or any other speculative use.

In the illustrated embodiment, the processor 10 includes the window management unit 16 to manage the register windows in the register file 14. The window management unit 16 may receive the register addresses (Rs) for register read and write operations from the core 12 and may ensure that the appropriate storage locations in the register file 14 are read/written based on the currently-active window. The corresponding data is communicated back and forth between the register file 14 and the core 12. Depending on the implementation, part of the register address may be provided directly to the register file 14 and the window management unit 16 may modify a remaining portion of the a register address to access the appropriate storage location the register file 14. The window management unit 16 may maintain a current window pointer (CWP) in the CWP register 18, indicating the currently active register window. Additional status data may be maintained in other registers, not shown in FIG. 1. The window management unit 16 may also be responsible for detecting window overflow (indicating that data from one or more register windows in the register file 14 are to be spilled to memory to permit allocation of the new window) or window underflow (indicating that data from previously spilled registers are to be reloaded into the register file 14, or erroneous program behavior has caused an attempted switch to a non-existent window). The window management unit 16 or other hardware in the processor 10 may handle the overflow/underflow, or the window management unit 16 may trap to software to handle the overflow/underflow.

Accordingly, the window management unit 16 may allocate register windows, including allocating register windows for run-ahead mode. The window management unit 16 may communicate with the run-ahead control unit 28 for such purposes.

The register file 14 may comprise multiple storage locations, each storage location corresponding to a register implemented by the processor 10. An exemplary location is illustrated within the register file 14 in FIG. 1. The storage location may include storage for data written to the register (e.g. “Value” in FIG. 1). Additionally, the register file 14 may include a not-data indication (e.g. “ND” in FIG. 1). For example, the not-data indication may be an ND bit that is set to indicate that the value is not valid data and clear to indicate that the value is valid. In other embodiments, the opposite meanings may be assigned to the set and clear states of the bit or other indications may be used.

The ND bit in each register may be used to support run-ahead mode. When run-ahead mode is entered, the target register of the load miss may be written with the ND bit set, indicating that the data is not valid because it has not been returned yet. If a source operand has the ND bit set when an instruction is processed in run-ahead mode, the core 12 may propagate the ND bit to the result of the instruction. As processing continues in run-ahead mode, additional registers may have their ND bits set. The core 12 may inhibit address generation and prefetching for loads and stores if one of the address operands from the register file 14 has its ND bit set, since the address is not likely to be accurately generated.

As previously noted, once the cache fill data is returned for the load miss that caused entry into the run-ahead mode, the core 12 begins normal execution again beginning from the load and reverting to the checkpointed register state. The program counter (PC) address corresponding to the checkpoint may be used to refetch the instructions. For example, the PC corresponding to the checkpoint may be the PC of the load miss instruction, or the PC of the instruction following the load miss instruction, in various embodiments. In some embodiments, the run-ahead control unit 28 may store the PC when entering run-ahead mode. In other embodiments, the PC may be stored elsewhere. For example, in the illustrated embodiment, the processor 10 includes the trap control unit 20 and the trap stack 22 for handling traps. If the core 12 detects a trap, the core 12 may signal the type of trap detected and provide the PC to the trap control unit 20. The trap control unit 20 may store the PCs on the trap stack 22, and may direct the core 12 to the trap vector to fetch and execute in response to the trap. Once the trap is complete, the PC may be retrieved from the trap stack 22 and execution may continue by fetching the PC.

The processor 10 may use the trap stack to store the PC when run-ahead mode is entered. That is, one or more trap stack entries may be unused at the time that run-ahead mode is entered. The trap control unit 20 may allocate an unused entry to store the PC corresponding to the load miss. The run-ahead control unit 28 may indicate when run-ahead mode is being exited, and the trap control unit 20 may provide the PC from the trap stack 22.

The external interface unit 24 may comprise circuitry for communicating with other circuitry external to the processor 10. For example, the external interface unit 24 may receive fill requests from the core 12 for cache misses, and may supply the fill data back to the core (or directly to the data cache 26) when it is received from the external interface. Any sort of external interface may be used (e.g. shared bus, point to point links, meshes, etc.).

It is noted that, while a miss signal is shown in FIG. 1 to indicate a cache miss, a hit signal can also be used to indicate a cache hit (and a miss may be detected if the hit signal is not asserted for a request).

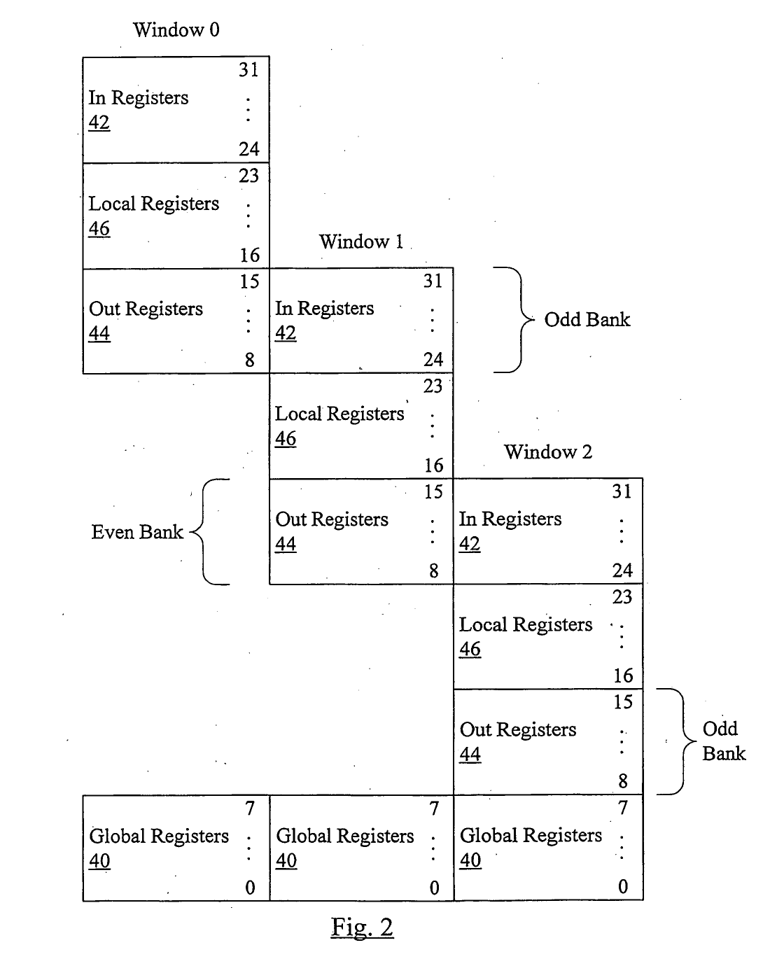

FIG. 2 is a block diagram illustrating one embodiment of exemplary register windows according to the SPARC ISA. Three adjacent windows are shown (window 0, window 1, and window 2). In the SPARC ISA, 8 registers of adjacent windows overlap. Implementations of the SPARC V9 ISA are permitted to implement any number of register windows between 3 and 32. An exemplary embodiment described in more detail herein implements 8 register windows, although any permitted number of windows may be implemented in other embodiments.

At any given point in time, the current window pointer (CWP) stored in the CWP register 18 identifies which of the implemented register windows is the current register window. The window save and restore instructions increment and decrement the CWP, respectively, thus changing the current register window to one of the adjacent windows. In FIG. 2, if the CWP indicates window 1, the previous window is window 0 (which may be restored by executing the restore instruction) and the next window to be allocated is window 2 (and window 1 may be saved and window 2 may be allocated by executing the save instruction). The next window to be allocated is also referred to as the successor window.

As mentioned above, the SPARC ISA defines a 24 register window along with 8 global registers to provide 32 general purpose integer registers that are addressable by instructions at any given point in time. That is, the instructions are encoded with 5 bit register addresses that can be used to address the 32 available integer registers. The register addresses 0 to 7 are assigned to the global registers (reference numeral 40 in FIG. 2). The global registers remain the same as the register windows are changed via modification of the CWP. The global registers are windowed according to trap level. In some embodiments, the higher trap levels (or the highest trap level) may be used to establish a checkpoint for global registers. The registers in the register window are assigned register addresses 8 to 31. More particularly, the register window may be divided into 3 sections of 8 registers each (the in registers 42, the out Registers 44, and the local Registers 46). The in registers 42 are assigned register addresses 24 to 31, the local registers 46 are assigned register addresses 16 to 23, and the out registers 44 are assigned register addresses 8 to 15. As FIG. 2 illustrates, the in registers 42 in a given register window overlap with the out registers 44 of the previous adjacent window (e.g. the in registers 42 of window 1 overlap with the out registers 44 of window 0). Similarly, the out registers 44 of the given register window overlap with the in registers 42 of the successor adjacent register window (e.g. the out registers 44 of window 1 overlap with the in registers 42 of window 2). The local registers 46 do not overlap with other registers and thus are private to the register window in which they are included. Registers that overlap between two register windows are defined to have the same register state (e.g. an update to an overlapping register in one of the windows affects the state in the overlapping register in the other window). In various implementations, the overlapping registers in each window may or may not refer to the same physical storage location within the register file.

A variety of register file embodiments may be possible to implement the integer registers, the register windows, and the correct state behavior for the overlapping registers. For example, register file embodiments in which any register is addressable via a port of the register file, using combinations of the CWP and register addresses to select the correct register within the current register window, are possible. Interlocks between the add result of the save/restore instructions and the establishing of the new register window in response to the save/restore may be avoided using the technique described below.

One embodiment of the register implements a set of active registers that can be accessed at any given time. That is, the active registers may be read to provide source operands for instructions and may be written as destinations for results of instructions. The active registers store the register state of the current register window. The remaining implemented registers may be implemented as shadow copies of the active registers. The shadow copies of a given register may store register state that corresponds to another register window (that is, a different register window than the current register window). The shadow copies may not be directly addressable from the ports of the register file, but may be coupled to an active register to capture state for storage or supply state for storage in the active register in a window swap operation.

In this embodiment, changing the current register window involves saving the current window state (that is, the state of the windowed registers) from the active registers to one of the shadow copies and restoring the window state from another one of the shadow copies to the active registers. The operation of saving one window state to a shadow copy and restoring a window state from another shadow copy is referred to herein as a “window swap” operation.

In some embodiments, each active register may have as many shadow copies as there are implemented register windows and the windowed registers may all be swapped with shadow copies to perform a window swap. However, it is possible to reduce the number of registers for which state is actually swapped when changing from the current register window to an adjacent register window, due to the overlap in registers between the current register window and the adjacent register window. For example, in FIG. 2, the in registers 42 of window 1 have the same state as the out registers 44 of window 0. Additionally, the difference between the register addresses in either window for the overlapping registers is that the most significant bit has the opposite state (e.g. register 31 in window 1 is the same as register 15 in window 0).

In some embodiments, the register file may be implemented with several “banks” of registers corresponding to the different regions of active registers shown in FIG. 2. Particularly, the register file may have a local bank for the active registers that are the local registers (register addresses 16 to 23), a global bank for the active registers that are the global registers (register addresses 0 to 7), and an odd bank and an even bank for the active registers corresponding to the in registers and the out registers (register addresses 8 to 15 and 24 to 31). If the CWP is even, the even register bank is mapped to the in registers and the odd register bank is mapped to the out registers. If the CWP is odd, the even register bank is mapped to the out registers and the odd register bank is mapped to the in registers. This dynamic mapping of the in and out registers to the odd and even register banks may be accomplished, e.g., by selectively changing the state of the most significant bit of register addresses within the in or out register address ranges based on whether or not the CWP is odd or even to generate the address presented to the register file. For example, the least significant bit of the CWP may be exclusive-ORed with the most significant bit of the register address if the register address is within the in and out register address ranges. For save/restore instructions, the destination register address is exclusive-ORed with the least significant bit of the CWP that corresponds to the new register window, if the destination register address is in the in or out register address ranges. FIG. 2 illustrates which registers are the even bank and the odd bank if the CWP for windows 0, 1, and 2 is 0, 1, and 2, respectively.

In the above embodiment, only one of the odd or even bank is swapped in a given window swap operation to an adjacent window, depending on whether the CWP is odd or even and the direction of the swap (e.g. to a previous window or a successor window of the current window). For example, if the CWP is even, the odd bank is swapped if the swap is to the previous window and the even bank is swapped if the swap is to a successor window. If the CWP is odd, the even bank is swapped if the swap is to the previous window and the odd bank is swapped if the swap is to a successor window. The local register bank is swapped in each window swap operation, and the global register bank is unaffected by window swap operations. Thus, swaps to adjacent windows may only cause 16 active registers to change state in embodiments implementing the SPARC ISA.

Swaps to non-adjacent windows may also occur (e.g. due to a write directly to the CWP register using a privileged instruction, due to an exception, due to returning from an exception handler after handling the exception). In such cases, all 24 registers may be swapped for embodiments implementing the SPARC ISA. For example, two window swap operations may be performed (one swapping 16 of the active registers and the other swapping the remaining 8 registers of the windows).

Specifically, a non-adjacent swap may be performed when allocating a register window for run-ahead mode. For example, if window 0 is the current window (and window 2 is currently unused), window 2 may be allocated since it has no overlapping registers with window 0.

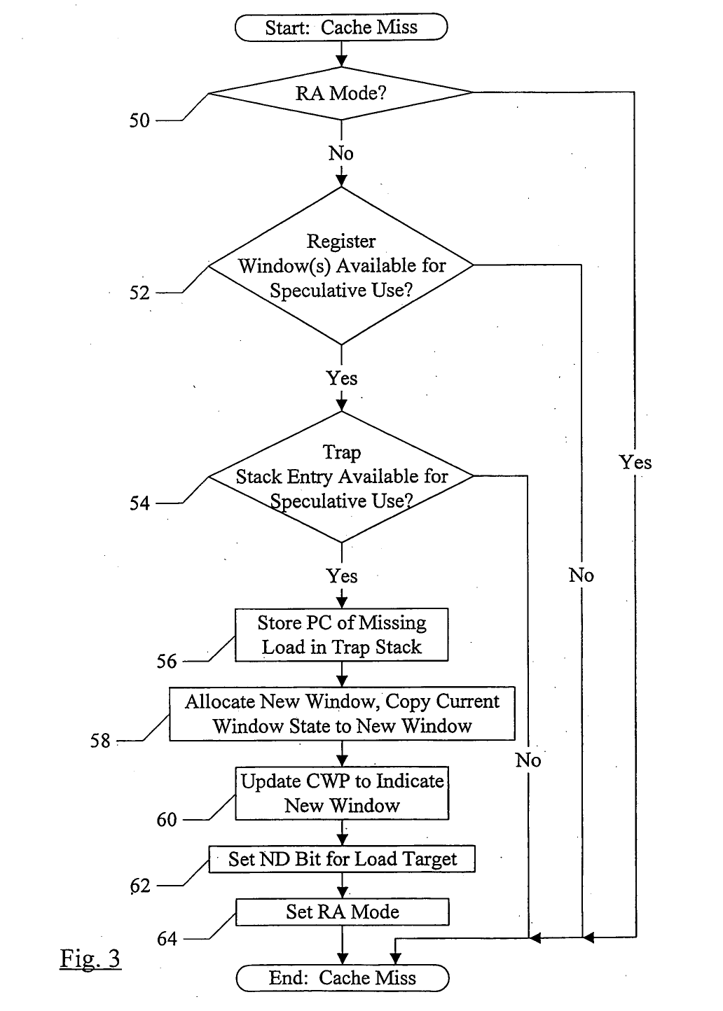

Turning now to FIG. 3, a flowchart is shown illustrating operation of one embodiment of the processor 10 in response to a load cache miss. Similar operation may occur for other long-latency events in other embodiments that enter run-ahead mode for such long-latency events. While the blocks are shown in a particular order for ease of understanding, other orders may be used. Blocks may be performed in parallel by combinatorial logic circuitry in the processor 10. Blocks, combinations of blocks, and/or the flowchart as a whole may be pipelined over multiple clock cycles.

The run-ahead control unit may detect the cache miss, and may determine if run-ahead mode is already active (decision block 50). If run-ahead mode is active (decision block 50, “yes” leg), the cache miss may be a subsequent cache miss detected by the run-ahead operation, and thus the cache fill may be initiated by the processor 10 and no additional action need be taken. If run-ahead mode is not yet active (decision block 50, “no” leg), the run-ahead control unit may determine if run-ahead mode can be entered (decision blocks 52 and 54). If there are no register window(s) available for speculative use (currently-unused windows—decision block 52, “no” leg), there is no place to checkpoint the current state of the registers while permitting speculative updates, and thus run-ahead mode may not be entered. If there are no trap stack entries available for speculative use (currently-unused—decision block 54, “no” leg), there is no place to store the PC to return to normal execution, and so the run-ahead mode may not be entered. There may be additional reasons why run-ahead mode may not be entered in other embodiments.

Otherwise, run-ahead mode may be entered. The trap control unit 20 may allocate the unused entry on the trap stack, and may store the PC in the entry (block 56). The window management unit 16 may allocate a non-overlapping register window and may copy the current window state to the new window (block 58). In this embodiment, the new window is used for the speculative updates, and thus the CWP is updated to point to the new window (block 60). The processor 10 may also set the ND bit in the register, within the new window, that corresponds to the load target register (block 62). The run-ahead control unit may set the RA bit to indicate that run-ahead mode is active (block 64).

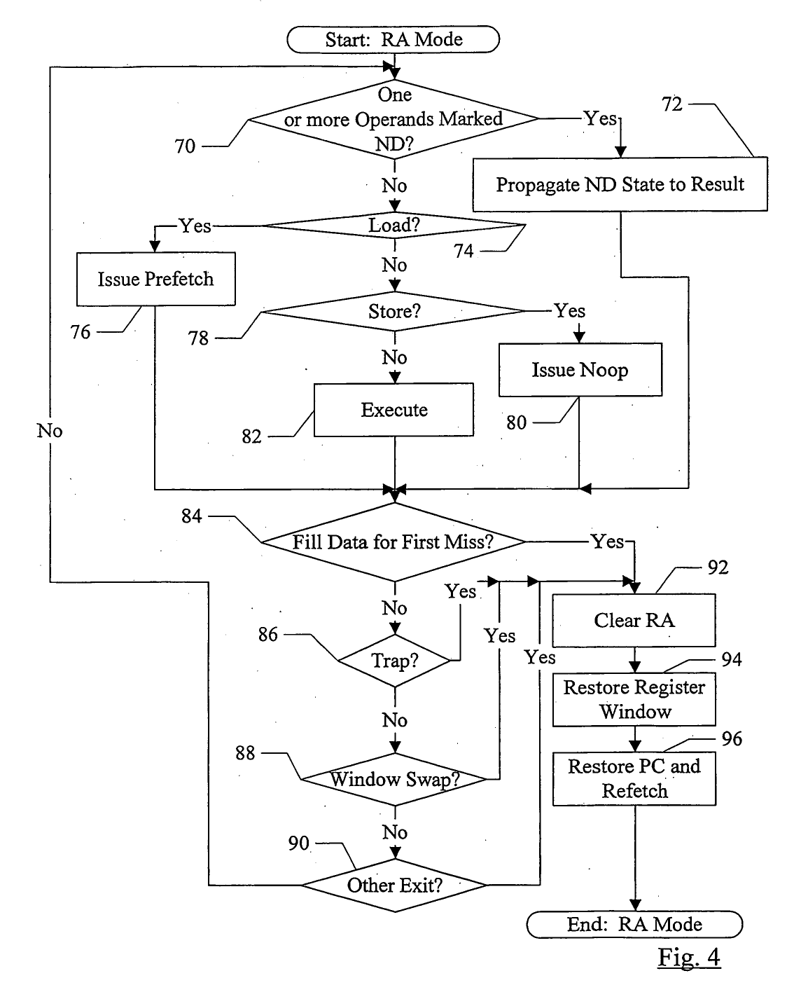

Turning now to FIG. 4, a flowchart is shown illustrating operation of one embodiment of the processor 10 while in run-ahead mode. While the blocks are shown in a particular order for ease of understanding, other orders may be used. Blocks may be performed in parallel by combinatorial logic circuitry in the processor 10. Blocks, combinations of blocks, and/or the flowchart as a whole may be pipelined over multiple clock cycles.

The core 12 may continue executing instructions subsequent to the load miss in the code sequence, changing the operation of some instructions and also propagating a not-data indication from one or more sources of an instruction to that instruction's target. Thus, the core 12 may check the ND bits corresponding to the source operand data from the register file 14 to determine if one or more operands is marked as not-data. If so (decision block 70, “yes” leg), the core 12 may write the target register of the instruction and mark the register as not-data (block 72). Note that, in this embodiment, if a source operand of a load is marked as not-data, the load is not executed. The address may not be likely to be generated correctly in such a case.

If the operand data is all indicated as data (valid), and the instruction is a load (decision block 74, “yes” leg), the core 12 may issue a prefetch operation for the load (block 76) and may mark the target register as not-data using the ND bit. The prefetch may attempt to determine if the memory location accessed by the load is in cache, and may issue a cache fill if the prefetch is a miss. Alternatively, the load may be executed normally to the data cache 26. If a miss is detected, a prefetch operation may be generated and the ND bit in the target register may be set. On the other hand, if the instruction is a store (decision block 78, “yes” leg), the core 12 may issue a no-operation (noop) instruction (block 80). Generally, the store instruction may be ignored and thus the memory location that is updated by the store may not be written. In some embodiments, the store may be converted into a prefetch as well. If the instruction is neither a load nor a store, the instruction may generally be executed and write a result to the register file 14 (block 82). There may be other instructions that are not executed, in some embodiments. For example, an instruction that updates a global register 40 may not be executed, since modifying the global registers would be retained when run-ahead mode is executed.

The run-ahead control unit 28 may also monitor for various events that cause run-ahead mode to exit. The fill data being returned to the data cache 26 for the initial load miss may be one event, and other events may cause exits in various embodiments. For the illustrated embodiment, the exit events include: the fill data being returned (decision block 84, “yes” leg); detection of a trap for an instruction (decision block 86, “yes” leg); detection of a window swap (e.g. a window save or restore instruction—decision block 88, “yes” leg); or any other exit event (decision block 90, “yes” leg). If no exit event is detected, the core 12 may continue executing in run-ahead mode. Other embodiments may use any subset or superset of the above exit events. For example, window swaps may not cause an exit if the window management unit 16 is designed to handle the swaps to windows adjacent to the checkpointed state.

If an exit event is detected, the run-ahead control unit 28 may clear the RA bit in the RA mode register 30 (block 92), restore the checkpointed register window (block 94), restore the PC from the trap stack 22, and refetch the instructions for continued execution in normal mode (block 96). Restoring the PC and refetching may be delayed until the fill data arrives for the initial load miss, if one of the other exit conditions is detected. Instruction execution may stall in the intervening time.

Restoring the checkpointed window, in the present embodiment, may involve changing the CWP back to the original window. In embodiments which use the newly allocated window as the checkpoint, the CWP may not be changed but the register state may be copied back from the newly allocated window to the current window.

Another mechanism which may use the register windows to create a checkpoint, either in addition to the run-ahead mode or without the run-ahead mode, is transactional memory. Generally, transactional memory may be an instruction set architecture enhancement which provides instructions to bracket a code sequence, indicating to the processor that the bracketed code sequence is to execute atomically. The processor may generally monitor cache blocks read during execution of the bracketed code sequence to detect if other processors write any of the cache blocks. If so, the code sequence did not execute atomically and the results of the code sequence are to be discarded. If the sequence does execute atomically, then the results are saved.

A transaction initialization instruction may indicate that the atomic code sequence is starting. Additionally, the transaction initialization instruction may supply an address to which the processor is to trap if the atomic code sequence fails to execute atomically. Alternatively, the address may be supplied with a commit instruction which terminates the code sequence. If the code sequence executed atomically, the commit succeeds and execution continues. If the code sequence did not execute atomically, the commit fails and the processor traps to the supplied address.

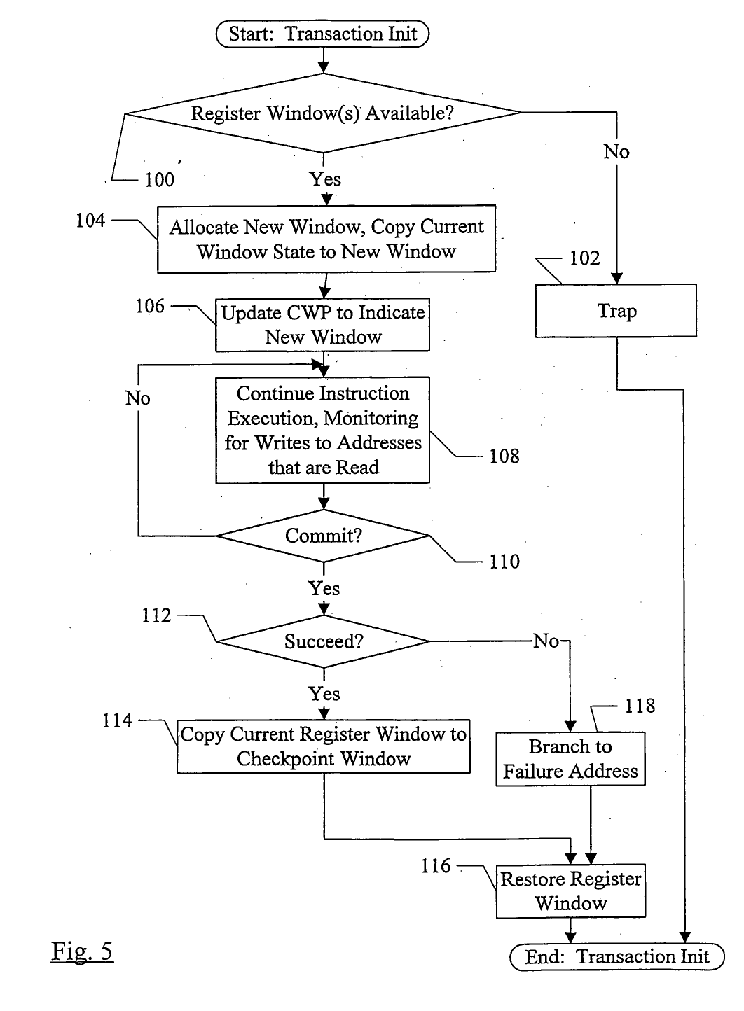

Turning now to FIG. 5, a flowchart is shown illustrating operation of one embodiment of the processor 10 to support transactional memory. While the blocks are shown in a particular order for ease of understanding, other orders may be used. Blocks may be performed in parallel by combinatorial logic circuitry in the processor 10. Blocks, combinations of blocks, and/or the flowchart as a whole may be pipelined over multiple clock cycles.

The flowchart of FIG. 5 begins with the execution of transaction initialization instruction. The processor 10 may check that a register window is available (not currently in use) so that register state can be checkpointed. If not (decision block 100, “no” leg), the processor 10 may trap to the address supplied by the transaction initialization instruction (block 102). If a register window is available, the window management unit 16 may allocate the register window and may copy the current window state to the new window (block 104). The window management unit 16 may also update the CWP to indicate that the newly allocated window is the current window (block 106). The processor 10 may continue execution, monitoring for writes to cache blocks that are read in the bracketed code sequence (block 108) until the commit instruction is encountered (decision block 110). When the commit instruction is encountered (decision block 110, “yes” leg), the processor 10 determines if the commit succeeds (decision block 112). That is, the processor 10 determines if the code sequence bracketed by the transaction initialization and commit instructions executed atomically. If so (decision block 112, “yes” leg), the processor 10 may copy the contents of the current register window to the checkpoint, thus committing the results (block 114). The window management unit 16 may restore the checkpoint window as the current register window (e.g. by updating the CWP—block 116). If the commit does not succeed (decision block 112, “no” leg), the processor 10 may branch, or trap, to the failure address supplied by the transaction initialization instruction (block 118). The processor 10 may also restore to the checkpointed window (block 116).

In another embodiment, the newly allocated window may be used as the checkpoint and the updates within the bracketed code sequence may be performed in the current register window. If the commit succeeds (which is typically the case for most transactions), then the current register window continues to be used and the checkpoint is discarded. The checkpoint may be copied back to the current register window if the memory transaction fails.

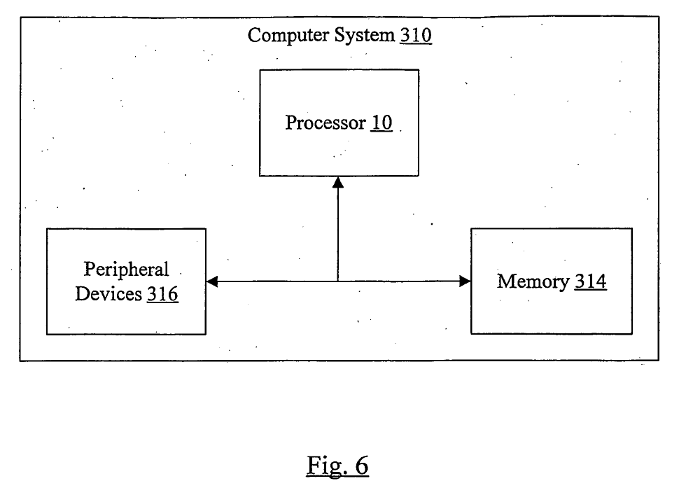

FIG. 6 is a block diagram of one embodiment of an exemplary computer system 310. In the embodiment of FIG. 6 the computer system 310 includes the processor 10, a memory 314, and various peripheral devices 316. The processor 10 is coupled to the memory 314 and the peripheral devices 316.

The processor 10 may be coupled to the memory 314 and the peripheral devices 316 in any desired fashion. For example, in some embodiments, the processor 10 may be coupled to the memory 314 and/or the peripheral devices 316 via various interconnect. Alternatively or in addition, one or more bridge chips may be used to couple the processor 10, the memory 314, and the peripheral devices 316, creating multiple connections between these components. Other embodiments may comprise multiple processors 10.

The memory 314 may comprise any type of memory system. For example, the memory 314 may comprise DRAM, and more particularly double data rate (DDR) SDRAM, RDRAM, etc. A memory controller may be included to interface to the memory 314, and/or the processor 10 may include a memory controller. The memory 314 may store the instructions to be executed by the processor 10 during use, data to be operated upon by the processor 10 during use, etc.

Peripheral devices 316 may represent any sort of hardware devices that may be included in the computer system 310 or coupled thereto (e.g. storage devices, other input/output (I/O) devices such as video hardware, audio hardware, user interface devices, networking hardware, etc.). In some embodiments, multiple computer systems may be used in a cluster.

Numerous variations and modifications will become apparent to those skilled in the art once the above disclosure is filly appreciated. It is intended that the following claims be interpreted to embrace all such variations and modifications.

What is claimed is:

1. A processor comprising:
a core configured to execute instructions;
a register file coupled to the core and comprising a plurality of storage locations; and
a window management unit coupled to the register file and the core, wherein the window management unit is configured to operate the plurality of storage locations as a plurality of windows, wherein register addresses encoded into the instructions identify storage locations among a subset of the plurality of storage locations that are within a current window of the plurality of windows, and wherein the window management unit is configured to allocate a second window of the plurality of windows in response to a predetermined event, and wherein one of the current window and the second window serves as a checkpoint of register state, whereby the register state is restorable, and wherein the other one of the current window and the second window is updated in response to instructions processed subsequent to the checkpoint.

2. The processor as recited in claim 1 wherein the predetermined event comprises entry into a run-ahead mode, and wherein the core is configured to enter the run-ahead mode in response to a cache miss for a load instruction executed by the core.

3. The processor as recited in claim 2 wherein each of the plurality of storage locations includes storage for a not-data indication identifying which of the plurality of storage locations stores valid data, and wherein the processor is configured to update the not-data indication in a storage location corresponding to a target register of the load instruction in the register file to indicate that the data is not valid.

4. The processor as recited in claim 3 wherein, in response to the core processing an instruction that has at least one operand in the register file for which the corresponding not-data indication indicates that the data is invalid, the processor is configured to propagate the not-data indication to a result operand of the instruction.

5. The processor as recited in claim 1 wherein adjacent ones of the plurality of windows overlap in the register file, and wherein the window management unit is configured to allocate the second window to be non-overlapping with the current window.

6. The processor as recited in claim 1 wherein the predetermined event comprises entry into a run-ahead mode, and wherein the core is configured to execute a load instruction in the run-ahead mode as a prefetch operation.

7. The processor as recited in claim 6 wherein the prefetch operation is performed if the load instruction is a cache miss.

8. The processor as recited in claim 6 wherein the core is configured to ignore a store instruction in the run-ahead mode.

9. The processor as recited in claim 6 wherein the core is configured to perform a prefetch operation in response to a store instruction in the run-ahead mode.

10. The processor as recited in claim 1 wherein the predetermined event comprises execution of a predefined instruction which indicates a start of a transactional memory operation.

11. The processor as recited in claim 10 wherein the window management unit, responsive to a commit instruction that terminates a transactional memory operation, is configured to selectively copy content from one of the second window and the current window to the other one of the second window and the current window in response to success or failure of the commit instruction.

12. In a processor configured to execute instructions and comprising a register file that is operated as a plurality of windows, wherein register addresses encoded into the instructions identify storage locations among a subset of the plurality of storage locations that are mapped to a current window of the plurality of windows, a method comprising:
detecting a predetermined event in the processor;
allocating a second window of the plurality of windows in response to the predetermined event;
using one of the current window and the second window as a checkpoint of register state; and
using the other one of the current window and the second window to store updates in response to instructions processed subsequent to the checkpoint.

13. The method as recited in claim 12 wherein the predetermined event comprises entering a run-ahead mode, and wherein entering the run-ahead mode is responsive to a cache miss for a load instruction executed by the processor.

14. The method as recited in claim 13 wherein each of the plurality of storage locations includes storage for a not-data indication identifying which of the plurality of storage locations are storing valid data, the method further comprising updating the not-data indication in a storage location corresponding to a target register of the load instruction in the register file to indicate that the data is not valid.

15. The method as recited in claim 14 further comprising:
processing an instruction that has at least one operand in the register file for which the corresponding not-data indication identifies the data as invalid; and
propagating the not-data indication to a result operand of an instruction in response to executing the instruction.

16. The method as recited in claim 12 wherein adjacent ones of the plurality of windows overlap in the register file, the method further comprising allocating the second window to be non-overlapping with the current window.

17. The method as recited in claim 12 wherein the predetermined event comprises entering a run-ahead mode, and the method further comprising executing a load instruction in the run-ahead mode as a prefetch operation.

18. The method as recited in claim 17 wherein the prefetch operation is performed if the load instruction is a cache miss.

19. The method as recited in claim 11 wherein the predetermined event comprises executing a predefined instruction which indicates a start of a transactional memory operation; and the method further comprises allocating a third window of the plurality of windows in response to the executing.

20. The method as recited in claim 19 further comprising:
executing a commit instruction that terminates a transactional memory operation; and
selectively copying a content of the second window to the current window in response to success or failure of the commit instruction.
